(19) United States
(12) Patent Application Publication
(10) Pub. No.: US 2013/0135219 A1
(43) Pub. Date: May 30, 2013

(54) Touchscreen Having A Color Coded 2-D Space

(71) Applicants: Ye Yin, Santa Clara, CA (US); Russell Wayne Gruhlke, Milpitas, CA (US)

(72) Inventors: Ye Yin, Santa Clara, CA (US); Russell Wayne Gruhlke, Milpitas, CA (US)

(73) Assignee: QUALCOMM MEMS TECHNOLOGIES, INC., San Diego, CA (US)

(21) Appl. No.: 13/307,866

(22) Filed: Nov. 30, 2011

(51) Int. Cl. G01B 11/14; G06F 3/041

(52) U.S. Cl. 345/173; 356/614

(57) ABSTRACT

This disclosure provides systems, methods and apparatus, including computer programs encoded on computer storage media, for two dimensional position determination of an object. In one aspect, a first electromagnetic (EM) radiation and a second EM radiation is emitted, along a plane, toward a position-sensing region, the first and second EM radiation each having a respective, different, wavelength. Scattered radiation, resulting from interaction of the emitted first and second EM radiation with an object located in the position-sensing region, is detected. Characteristics of the detected scattered radiation have a correlation with a position of the object in the position-sensing region. A two dimensional position of the object is determined, from the correlation. The position-sensing region may be co-planar with, and/or disposed proximate and parallel to an external surface of a display screen.

### TECHNICAL FIELD

This disclosure relates generally to a two dimensional position determining device, and, more specifically, to a display screen user input/output device or touchscreen that senses and locates the position of a “touch”.

### DESCRIPTION OF THE RELATED TECHNOLOGY

Electromechanical systems (EMS) include devices having electrical and mechanical elements, actuators, transducers, sensors, optical components (such as mirrors and optical film layers) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Electronic devices such as personal computers, point of sale devices, and personal electronic devices such as smart phones increasingly feature a touchscreen user interface. Although a number of touchscreen technologies are relatively mature, the power demand, cost, durability and reliability of known techniques present barriers to use and/or undermine user satisfaction. For example, “electronic-touch” devices such as resistive and capacitive screens generally employ transparent layers of indium tin oxide (ITO) stacked together and separated by a thin space. The ITO layers are relatively costly, tend to degrade screen clarity, and have poor durability. Electronic-touch devices commonly employ an embedded “grid” of thin electrodes that, while normally invisible to the naked eye, do noticeably reduce the brightness, contrast of the screen and may induce visually noticeable artifacts in displayed image.

“Optical-touch” screens avoid the need for ITO layers, and are generally more transparent than electronic-touch devices. Known techniques (requiring, for example, multiple sensors of multiple light emitters) have an undesirably poor signal to noise ratio.

### SUMMARY

The systems, methods and devices of the disclosure each have several innovative aspects, no single one of which is solely responsible for the desirable attributes disclosed herein.

One innovative aspect of the subject matter described in this disclosure includes an apparatus for determining a two dimensional position of an object. The apparatus includes a first radiating element configured to emit, along a plane, first electromagnetic (EM) radiation toward a position-sensing region, the first EM radiation having a first wavelength. A second radiating element is configured to emit second EM radiation along the plane toward the position-sensing region, the second EM radiation having a second wavelength different from the first wavelength. A radiation sensor is configured to detect scattered radiation, the detected scattered radiation resulting from interaction of the emitted first and second EM radiation with an object located in the position-sensing region. Characteristics of the detected scattered radiation have a correlation with a position of the object in the position-sensing region, and the apparatus is configured to determine, from the correlation, a two dimensional position of the object.

In some implementations, the apparatus may be a display screen having an external surface substantially parallel to the plane. The external surface may be proximate to the position-sensing region. The display screen and position-sensing region may be referred to hereinafter, collectively, as a “touchscreen” display.

The first and second wavelengths may be in the visible light range, and the first wavelength may correspond to a first color, while the second wavelength may correspond to a second color. The radiation sensor may include a color sensor configured to determine a color of the detected scattered radiation; and the correlation may be based on the color of the detected scattered radiation. The radiating elements may be light emitting diodes (LEDs) or lasers.

In some implementations, the apparatus may include a processor coupled to the radiation sensor, the processor configured to determine two dimensional coordinates of the position of the object in the position-sensing region based on the correlation. The processor may be configured to determine a relative strength of a first scattered radiation compared to a second scattered radiation, wherein the first scattered radiation results from interaction of the emitted first EM radiation with the object and the second scattered radiation results from interaction of the emitted second EM radiation with the object.

The first wavelength and the second wavelength may be in a frequency range of EM radiation, the frequency range being selected from the group consisting of infrared radiation, visible light, and ultraviolet radiation.

In some implementations, the apparatus may include a medium situated in the position-sensing region of the plane. The medium may be a transparent light guide or air.

In some implementations, the apparatus may include a third radiating element configured to emit third EM radiation along the plane toward the position-sensing region, the third EM radiation having a third wavelength different from the first wavelength and the second wavelength.

The apparatus may also include a touchscreen display, a processor and a memory device. The touchscreen display may include a display screen and the position-sensing region, and have an external surface substantially parallel to the plane and proximate to the position-sensing region. The processor may be configured to communicate with the display screen, and to process image data. The memory device may be configured to communicate with the processor, and the touchscreen display may be configured to receive input data and to communicate the input data to the processor. The apparatus may further include a driver circuit configured to send at least one signal to the display, a controller configured to send at least a portion of the image data to the driver circuit, and/or an image source module configured to send the image data to the processor. The image source module may include a receiver, a transceiver, and/or a transmitter.

In some implementations, a plurality of first radiating elements may each be configured to emit, along a plane, modulated first electromagnetic (EM) radiation toward a respective portion of a position-sensing region, the modulated first EM radiation having a first wavelength. Each of the plurality of first radiating elements may be modulated in a mutually distinct manner. A plurality of second radiating elements may each be configured to emit, along a plane, modulated second EM radiation toward a respective portion of a position-sensing region, the modulated second EM radiation having a second wavelength different from the first wavelength. Each of the plurality of second radiating elements is modulated in a mutually distinct manner. Characteristics of the detected scattered radiation, that may result from a first intensity and a first duty cycle of the modulated first EM radiation and a second intensity and a second duty cycle of the modulated second EM radiation, may have a correlation with a position of one or more objects in the position-sensing region, and the apparatus may be configured to determine, from the correlation, a two dimensional position of the one or more objects. A processor may be coupled to the radiation sensor, and the processor may be configured to determine, from the correlation, a two dimensional position of the object. The processor may further be configured to determine, from the correlation, a two dimensional position of at least two objects simultaneously present in the position-sensing region.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIGS. 9A-9F show an example of an arrangement for determining a position of an object within a 2-D position-sensing region.

FIG. 10 shows an example of the arrangement of FIGS. 9A and 9B illustrating how emitted radiation may interact with an object in a position-sensing region.

FIG. 11 shows an example of a flow diagram illustrating a method for determining a two dimensional position of an object.

FIGS. 12A and 12B show examples of system block diagrams illustrating a display device that includes a plurality of interferometric modulators.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (e.g., video) or stationary (e.g., still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (e.g., display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Described herein below are techniques for 2-D position determination that enable avoidance of an embedded grid of electrodes that can reduce transparency of a display screen user input/output device (referred to hereinafter as a “touchscreen”). Using the present techniques, a 2-D space is encoded whereby the touchscreen (sometimes referred to as an “optical touchscreen”) senses and locates the position of a “touch”.

An example of a suitable display device, for which the techniques described herein below may be implemented, is a reflective EMS or MEMS-based display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity. One way of changing the optical resonant cavity is by changing the position of the reflector.

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, absorbing and/or destructively interfering light within the visible range. In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, such as chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and electrical conductor, while different, electrically more conductive layers or portions (e.g., of the optical stack 16 or of other structures of the IMOD) can serve to bus signals between IMOD pixels. The optical stack 16 also can include one or more insulating or dielectric layers covering one or more conductive layers or an electrically conductive/optically absorptive layer.

In some implementations, the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, a voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

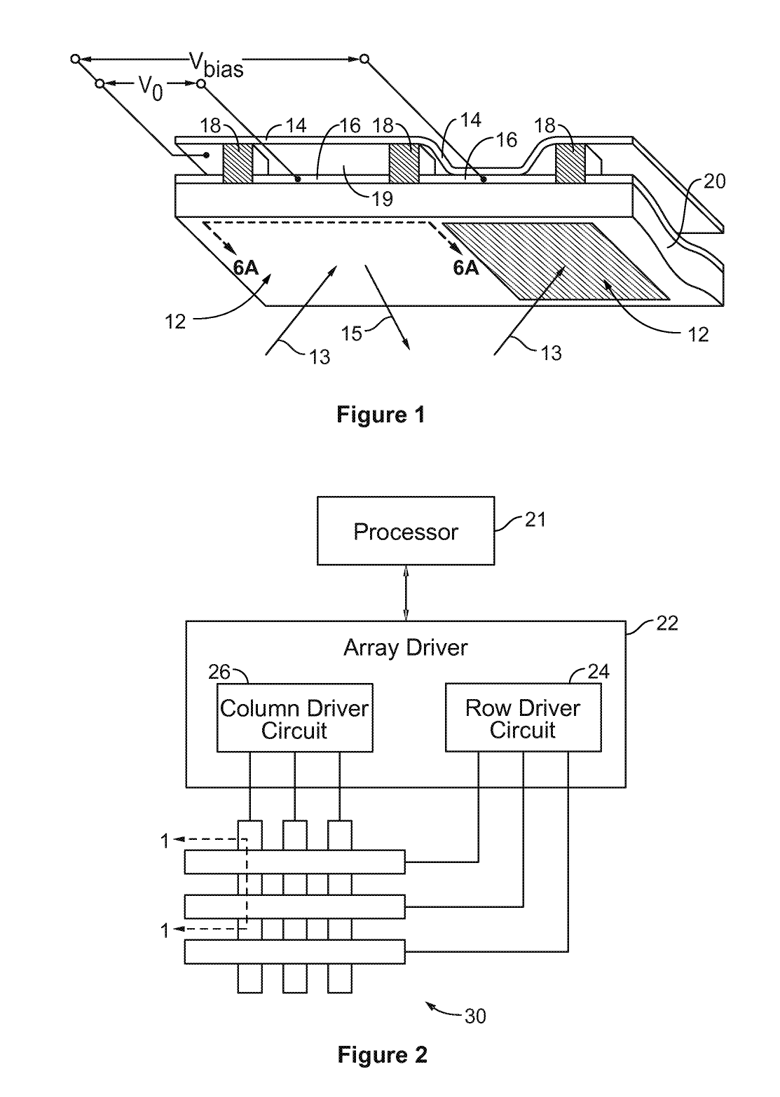

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example, a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

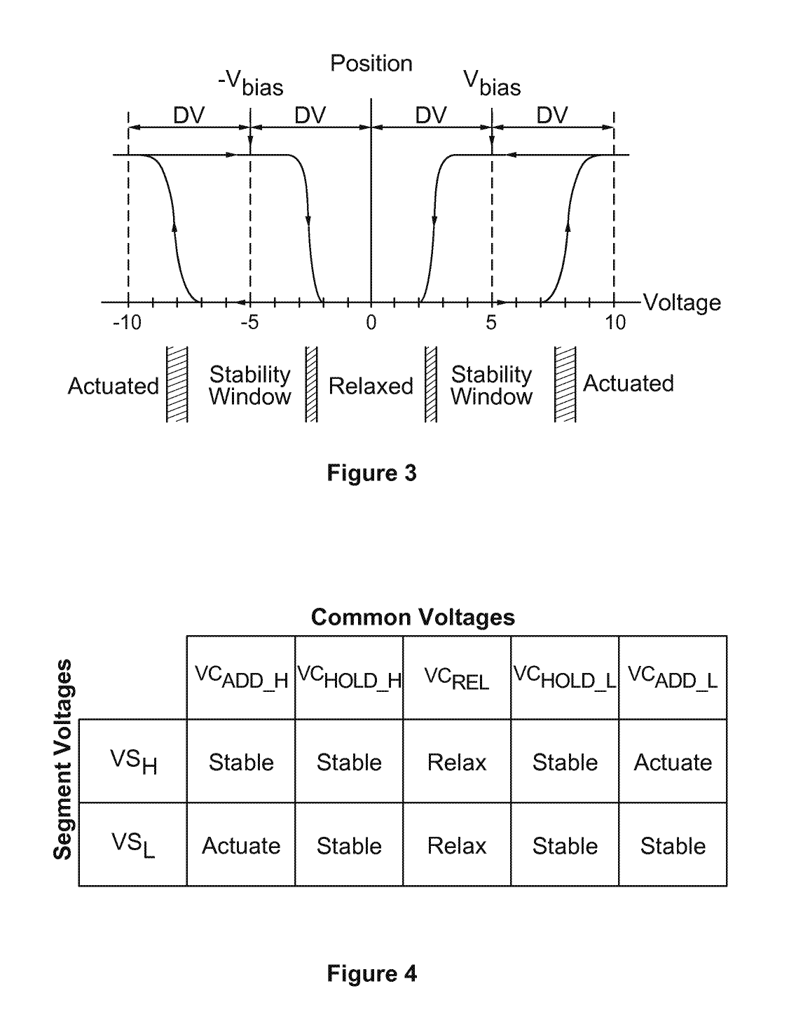

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts; however, the movable reflective layer does not relax completely until the voltage drops below 2 volts. Thus, a range of voltage, approximately 3 to 7 volts, in this example, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about, in this example, 10 volts, and pixels that are to be relaxed are exposed to a voltage difference of near zero volts. After addressing, the pixels can be exposed to a steady state or bias voltage difference of approximately 5 volts in this example, such that they remain in the previous strobing state. In this example, after being addressed, each pixel sees a potential difference within the “stability window” of about 3-7 volts. This hysteresis property feature enables the pixel design, such as that illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be understood by one having ordinary skill in the art, the “segment” voltages can be applied to either the column electrodes or the row electrodes, and the “common” voltages can be applied to the other of the column electrodes or the row electrodes.

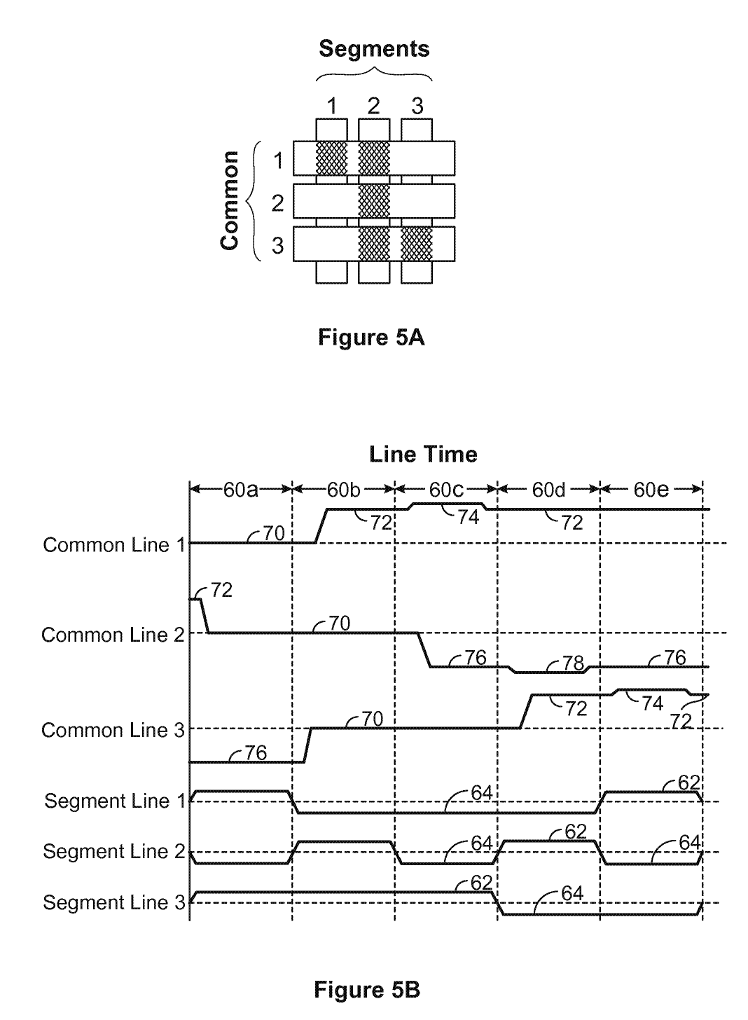

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator pixels (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to a 3×3 array, similar to the array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, for example, a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

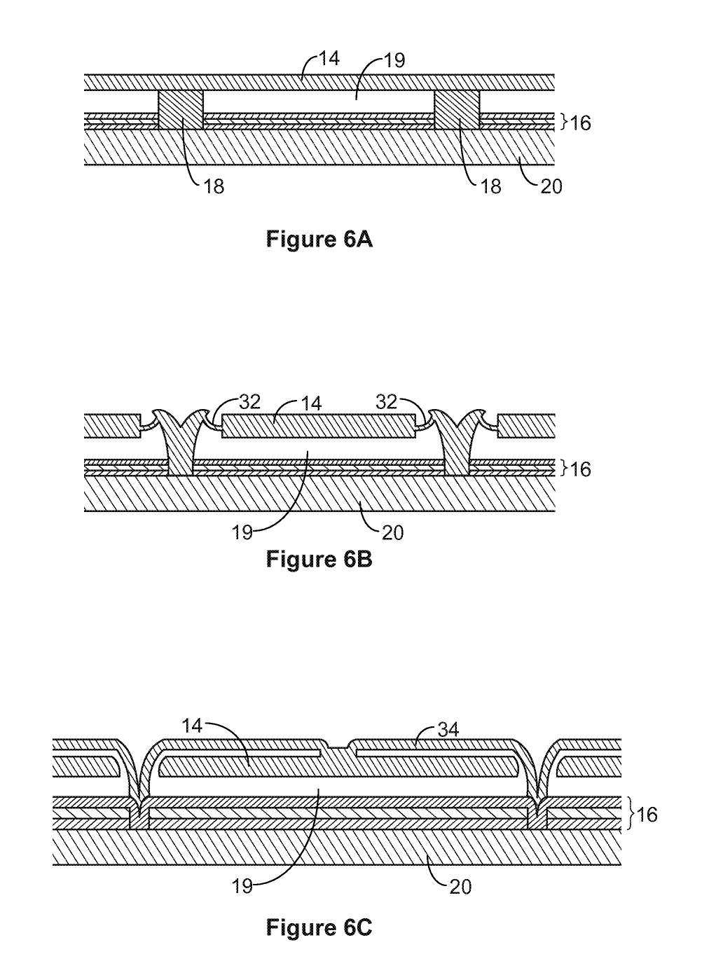

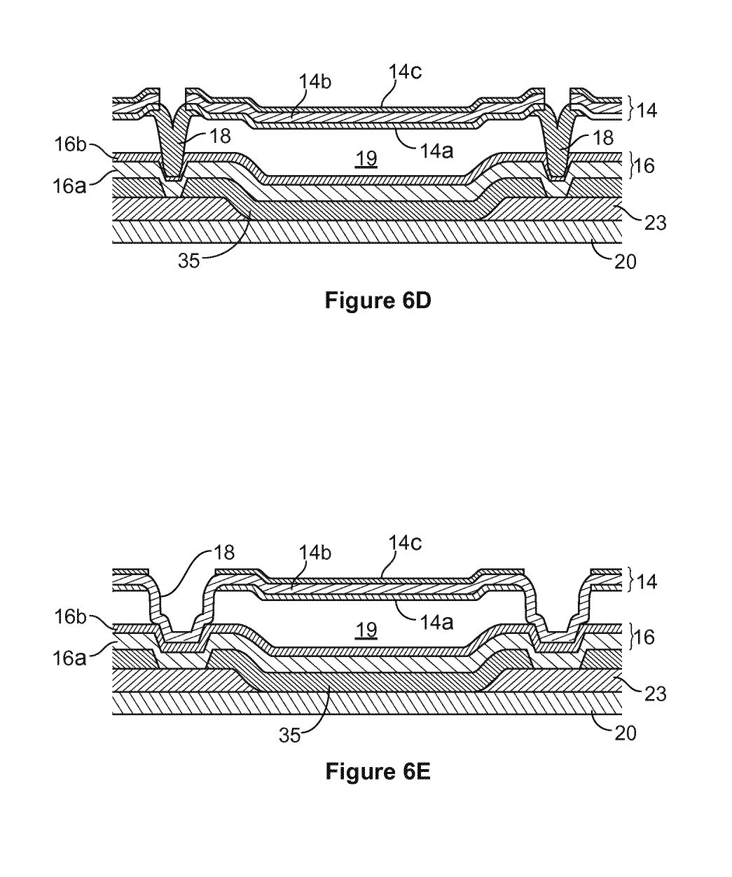

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, for example, an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (such as between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer. In some implementations, the optical absorber 16a is an order of magnitude (ten times or more) thinner than the movable reflective layer 14. In some implementations, optical absorber 16a is thinner than reflective sub-layer 14a.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, for example, patterning.

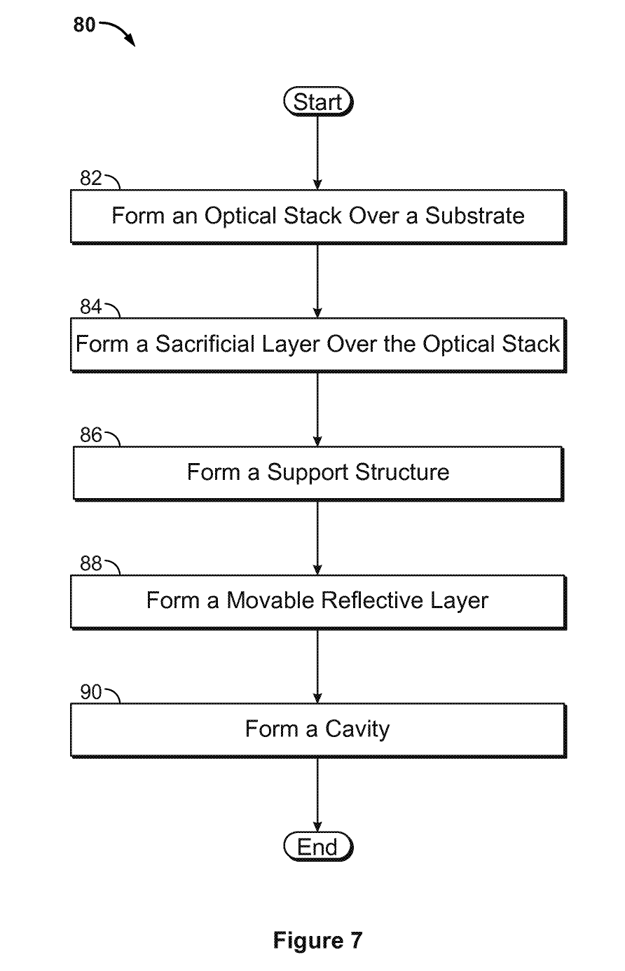

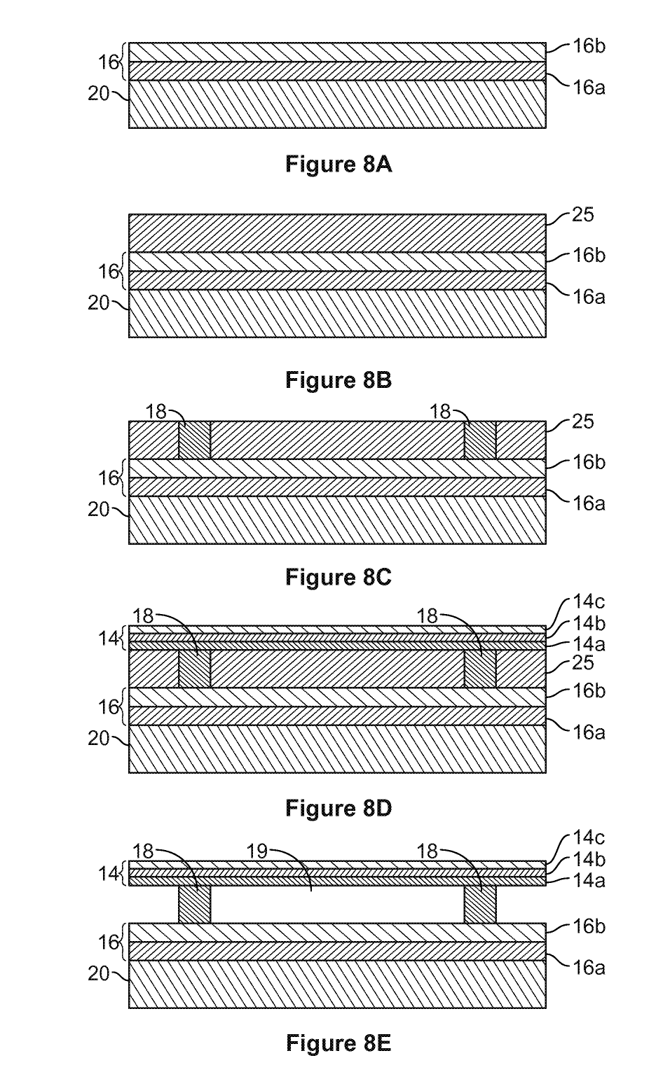

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture an electromechanical systems device such as interferometric modulators of the general type illustrated in FIGS. 1 and 6. The manufacture of an electromechanical systems device can also include other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, such as cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display. It is noted that FIGS. 8A-8E may not be drawn to scale. For example, in some implementations, one of the sub-layers of the optical stack, the optically absorptive layer, may be very thin, although sub-layers 16a, 16b are shown somewhat thick in FIGS. 8A-8E.

The process 80 continues at block 84 with the formation of a sacrificial layer 25 over the optical stack 16. The sacrificial layer 25 is later removed (see block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a—Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as post 18, illustrated in FIGS. 1, 6 and 8C. The formation of the post 18 may include patterning the sacrificial layer 25 to form a support structure aperture, then depositing a material (such as a polymer or an inorganic material such as silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps including, for example, reflective layer (such as aluminum, aluminum alloy, or other reflective layer) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, such as cavity 19 illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, by exposing the sacrificial layer 25 to a gaseous or vaporous etchant, such as vapors derived from solid XeF₂, for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

According to one innovative aspect of the subject matter described in this disclosure, a display screen, which may be associated with an IMOD display device as described hereinabove, has a positioning determination arrangement. In implementations of the positioning determination arrangement, each of two or more radiating elements emits, along a plane, a respective electromagnetic (EM) radiation toward a position-sensing region. The position-sensing region may be coplanar with an external surface of the display screen, or disposed proximate to and parallel with the display screen. The display screen and position-sensing region together may be referred to hereinafter, for convenience as a “touchscreen” display. It should be noted, however, that the position-sensing region may be disposed a finite distance from the external surface of the display screen, so that a position of an object may be sensed without an actual physical “touching” of the external surface. Moreover, a “touch”, as used herein, may include short duration and/or high frequency “tap-like” interactions of the object with the position-sensing region. EM radiation from a first radiating element is at a first wavelength and EM radiation from a second radiating element is at a second wavelength, different from the first wavelength. A radiation sensor detects scattered radiation, the detected scattered radiation resulting from interaction of the emitted first and second EM radiation with an object located in the position-sensing region. Characteristics of the detected scattered radiation have a correlation with a position of the object in the position-sensing region. The positioning determination arrangement is configured to determine, from the correlation, a two dimensional position of the object.

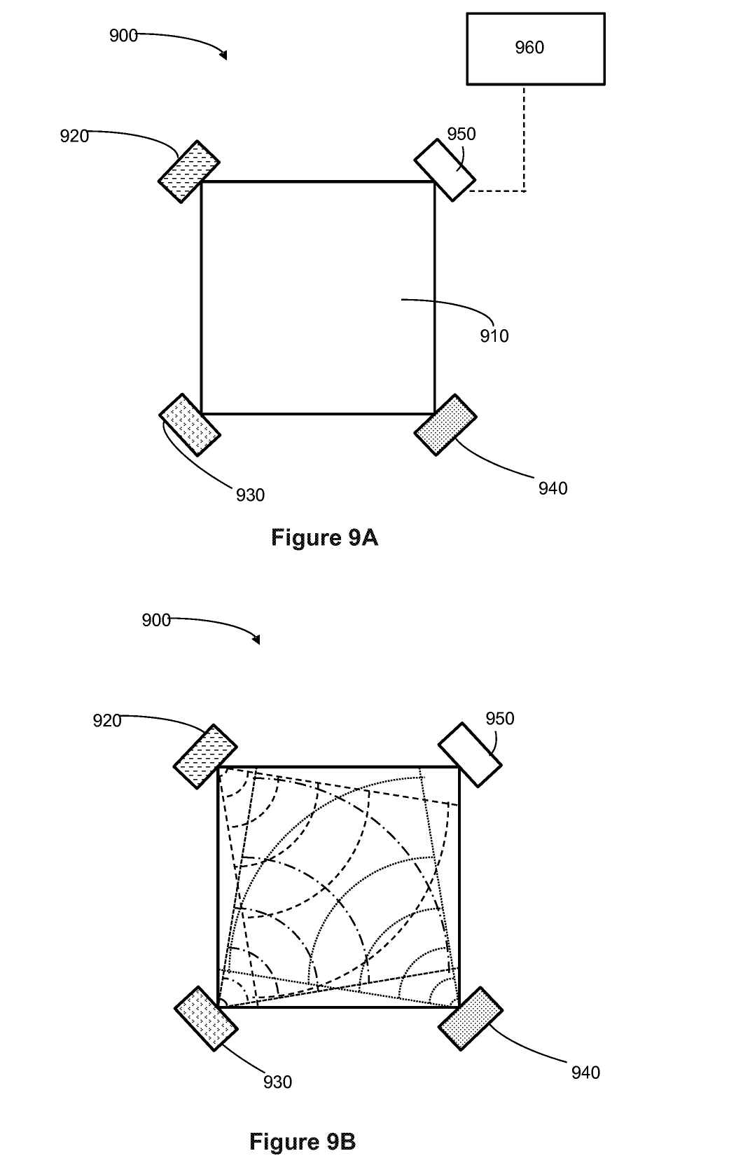

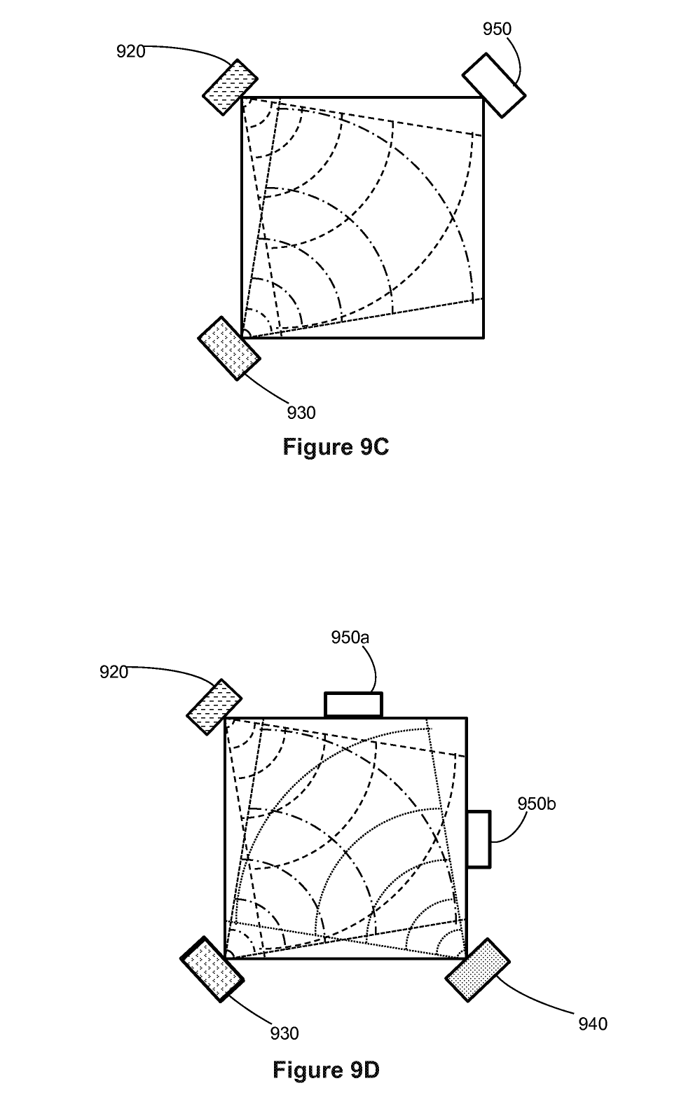

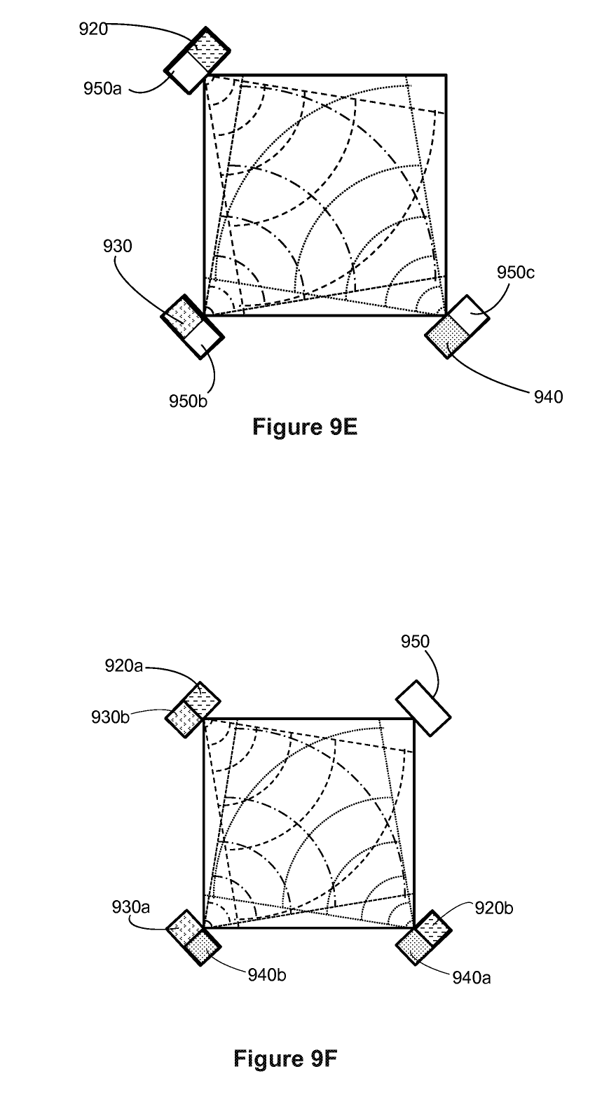

FIGS. 9A and 9B show an example of an arrangement 900 for determining a position of an object within 2-D position-sensing region 910. A first radiating element 920 emits electromagnetic (EM) radiation, having a first wavelength, along a plane that is within or parallel to the plane of the drawing. In the illustrated arrangement, for example, first radiating element 920 is a light emitting diode (LED) emitting visible light at a wavelength associated with red light. A second radiating element 930 emits EM radiation, having a second wavelength, along the plane. In the illustrated implementation, for example, second radiating element 930 is an LED emitting visible light at a wavelength associated with blue light. A third radiating element 940 emits EM radiation, having a third wavelength, along the plane. In the illustrated implementation, for example, third radiating element 940 is an LED emitting visible light at a wavelength associated with green light. It is to be understood that, while radiation elements 920, 930 and 940 may be described as emitting at a particular wavelength, practical radiating elements will actually emit a band of wavelengths about a given particular wavelength.

A radiation sensor 950 detects “scattered” radiation, the scattered radiation resulting from interaction of the emitted EM radiation with an object (not shown) located in position-sensing region 910. In the illustrated implementation, for example, radiation sensor 950 is a color sensor that determines the color of the detected scattered radiation.

More generally, referring now to FIG. 9C, first radiating element 920 may be configured to emit, along a plane, a first electromagnetic radiation at a first wavelength toward position-sensing region 910. Second radiating element 930 may be configured to emit, along the plane, second electromagnetic radiation at a second wavelength different from the first wavelength toward position-sensing region 910. Radiation sensor 950 may be configured to detect scattered radiation from the emitted radiation responsive to an object scattering the emitted radiation.

It is to be understood that, although the example implementation illustrated in FIGS. 9A, 9B, and 9C has emitters and sensors located proximate to a respective corner of a rectangular position-sensing region, other arrangements are within the contemplation of the present disclosure. For example, one or more of the emitters may be located near a mid-point of a side of the position-sensing region. Furthermore, the position-sensing region need not be rectangular.

Moreover, in some implementations, two or more radiation sensors 950 may be provided. For example, as illustrated in FIG. 9D, in an implementation, first radiation sensor 950a may be disposed on or near a mid-point of a first side of the rectangular position-sensing region, whereas second radiation sensor 950b may be disposed on or near a mid-point of a second side of the rectangular position-sensing region. Although illustrated with only two radiation sensors 950a and 950b, it is understood that in some implementations, a more than two radiation sensors can be used, for example, three or four radiation sensors.

As a yet further example, in some implementations, one or more of the radiating elements 920, 930, and 940 may be proximate to, or integrated with a radiation sensor. In the implementation illustrated in FIG. 9E, for example, radiating element 920 is integrated with radiation sensor 950a, radiating element 930 is integrated with radiation sensor 950b, and radiating element 940 is integrated with radiation sensor 950c, As a result, light emitted by, for example, radiating element 920 may be scattered back toward the integrated radiation sensor 950a and/or scattered toward all of radiation sensors 950a, 950b and 950c. Although illustrated with three radiating elements 920, 930 and 940, each integrated with a radiation sensor 950a, 950b and 950c, it will be understood that in some implementations, more than three radiating elements integrated with radiation sensors may be used. In one example, four radiating elements, each integrated with a radiation sensor may be used.

The position-sensing region may be associated with a display of an electronic device such as, but not limited to, mobile telephones, multimedia Internet enabled cellular telephones, smartphones, personal data assistants (PDAs), wireless electronic mail receivers, hand-held or portable computers, netbooks, notebooks, smartbooks, electronic reading devices (e.g., e-readers), computer monitors, and the like.

The wavelengths of the electromagnetic radiation emitted from the radiating elements may be in various frequency ranges, such as infrared (IR) radiation, visible light, and ultraviolet radiation, depending on the desired application. For example, as illustrated in FIG. 9A, radiating elements in the form of three (3) different LEDs with respective saturated primary colors (Red, Green, and Blue) may be provided. Other electromagnetic radiation sources (with an appropriate wavelength discriminating radiation sensor) are also within the contemplation of the present inventors. For example, lasers (which may be coupled with a diffuser or lens to diffuse the laser light over a portion of the 2-dimensional plane) may be used in addition to, or instead, of LEDs.

Radiation sensors (such as radiation sensor 950 of FIGS. 9A, 9B, 9C, and 9F, or radiation sensors 950a and 950b of FIG. 9D or radiation sensors 950a, 950b, and 950c of FIG. 9E) may be any sensor capable of wavelength or color discrimination. In various implementations, a radiation sensor may include multiple photodiodes, where each photodiode is matched with a color filter so that the radiation sensor provides multiple outputs, each of the multiple outputs indicating the intensity of light for a given color. In some implementations, for example, each photodiode is matched with one of a Red, Green, or Blue color filter. In this example, each photodiode may then provide a reading of the intensity or strength of Red, Green, or Blue components in the scattered light. In alternative implementations, particularly implementations with multiple radiation sensors, each radiation sensor may include only one photodiode with only one color filter to provide only one output indicating the intensity of light for only color.

In an implementation, a medium is situated in position-sensing region 110. The medium may be air, or it may be transparent light guide fabricated, for example, from glass or acrylic. For example, a planar light guide may be provided within which radiation emitted from radiating elements 920, 930, and 940 (if present) may be substantially contained. In some implementations, the transparent light guide is sufficiently flexible so that, when touched, the deformation of the light guide at the location of the touch provides sufficient scattering of light for radiation sensors (such as sensor 950) to detect light.

In some implementations, a display screen, which may be included in an IMOD display device as described hereinabove, may utilize the present 2-D position-sensing techniques. For example, the display screen may have an external surface proximate to and substantially parallel to the position-sensing region. Advantageously, a viewable area of the display screen may be substantially co-extensive with the position-sensing region. The display screen may be rectangular, in which case up to three radiating elements may each be disposed proximate to a respective corner, while a fourth corner may be occupied by radiation sensor 950. Additional radiation sensors (not illustrated) may be also be placed along sides of the position-sensing region or in corners, for example, adjacent to radiating elements 920, 930, and 940. Alternatively, however, one or more radiating elements and/or radiation sensor 950 may be disposed proximate to a respective side.

In an implementation, radiation sensor 950 may be located substantially in the same plane as radiating elements 920, 930, and 940 (if present). A processor 960 may be coupled to radiation sensor 950 and be configured to determine 2-D coordinates of the position of the object in the region of the plane based on the detected scattered radiation, as described in more detail herein below.

Due to the spatial separation of radiating elements 920, 930, and 940, each coordinate in the position-sensing region has a different characteristic “color”, or band of wavelengths. Referring to FIG. 9B, for example, it is illustrated how different light intensities of red, green, and blue light at a particular location depend upon the distance of each of the first, second, and third radiating elements 920, 930, and 940 from the location. The different light intensities, coupled with additive color mixing, results in a 2-D position-sensing region space that is color-coded. That is, each location, which may be defined by an (X, Y) coordinate has a unique combination of color densities. Radiation scattered from an object at that coordinate will likewise have a unique characteristic. Put another way, characteristics of the scattered radiation will have a correlation with a position of the object in the position-sensing region.

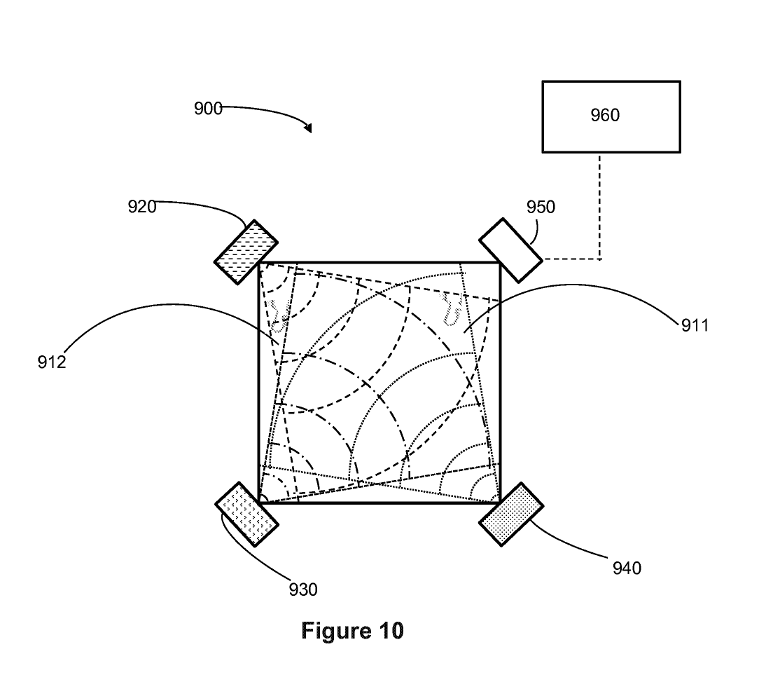

FIG. 10 shows an example of the arrangement of FIGS. 9A and 9B, illustrating how emitted radiation may interact with an object in a position-sensing region. When a finger or other object enters the position-sensing region, it scatters the emitted radiation. Some of the scattered emitted radiation will reach the radiation sensor 950. Characteristics of the radiation arriving at the radiation sensor (the “detected scattered radiation”) may be analyzed by processor 960 to determine the X, Y position of the object, as shown in FIG. 10. For example, when the object touches region 911 of position-sensing region 910, scattered light of a first particular color and intensity will be received by radiation sensor 960. When the object touches magenta region 912 of position-sensing region 910, scattered light of a second particular color and intensity will be received by the radiation sensor. Thus, characteristics of the detected scattered radiation will have a correlation with the position touched by the object. Advantageously, the correlation may be used to determine the two dimensional position of the object. In one implementation, determination of the two dimensional position is accomplished by processor 960 coupled to radiation sensor 950. For example, processor 960 may determine a relative strength of radiation scattered from the object of each of a first EM radiation and a second EM radiation.

In some implementations, a two dimensional position determination of at least two objects simultaneously present in the position-sensing region may be facilitated. For example, two or more radiating elements may each be configured to emit a modulated first EM radiation of a first wavelength toward a respective portion of a position-sensing region, such that each radiating element is modulated in a mutually distinct manner. For example, one radiating element having the first wavelength may be pulsed on/off at a first duty cycle, whereas a second radiating element having the first wavelength may be pulsed on/off at different duty cycle. In an implementation illustrated in FIG. 9F, for example, radiating elements 920a and 920b may each emit light associated with a first color, and radiating element 920a may be modulated by, for example, a mutually distinct duty cycle from the duty cycle of radiating element 920b. Radiating elements 930a and 930b may each emit light associated with a second color, and each may be modulated by, for example, a mutually distinct duty cycle. Radiating elements 940a and 940b may each emit light associated with a second color, and be modulated by, for example, a mutually distinct duty cycle. Using the additional information provided by providing at least two radiating elements emitting light of a given color at a mutually distinct modulation, a processor may be configured to determine a two dimensional position of at least two objects simultaneously present in the position-sensing region.

In some implementations, normalization of the color field may be achieved with highly accurate control of the spectrum/intensity of each radiation emitter and the scattered light can be detected with a high resolution radiation sensor. As a result, the number of color coordinates can be very large, and the effective signal to noise ratio of the optical touch apparatus may be significantly improved.

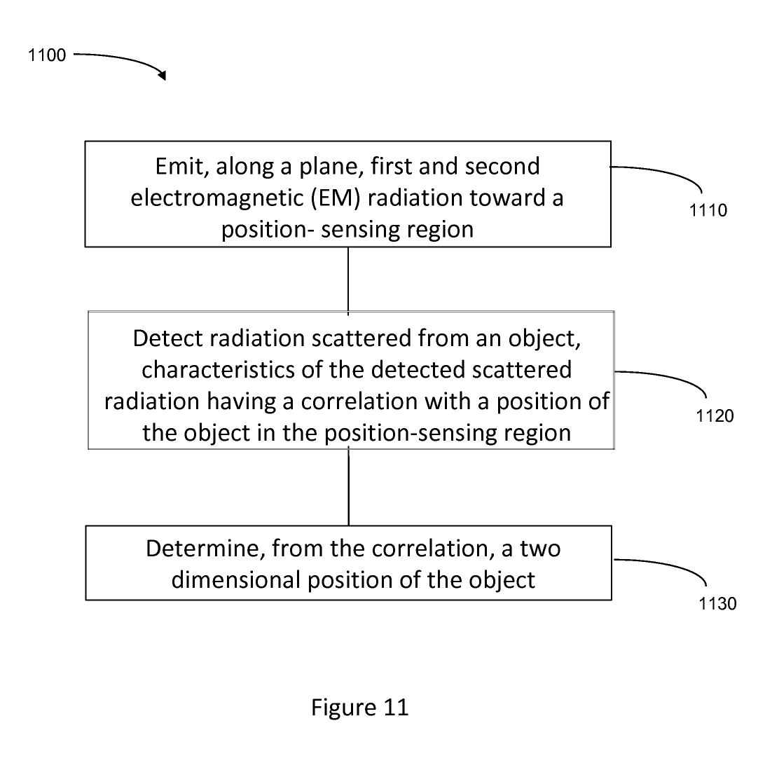

FIG. 11 shows an example of a flow diagram illustrating a method 1100 for determining a two dimensional position of an object. At block 1110, first and second EM radiation may be emitted, along a plane, toward a position-sensing region. The first EM radiation may have a first wavelength or a first band of wavelengths about the first wavelength; the second EM radiation may have a second wavelength, or a second band of wavelengths about the second wavelength, the second wavelength being different from the first wavelength. For example, the first and second EM radiation may be emitted by a respective LED, emitting light at a visual, IR or UV wavelength.

At block 1120, radiation scattered from an object may be detected. The detected scattered radiation may result from interaction of the emitted first and second EM radiation with an object located in the position-sensing region. Characteristics of the detected scattered radiation may have a correlation with a position of the object in the position-sensing region.

At block 1130, a two dimensional position of the object may be determined from the correlation. For example, a position determination may be made by a processor receiving signals representative of detected scattered radiation from one or more radiation sensors.

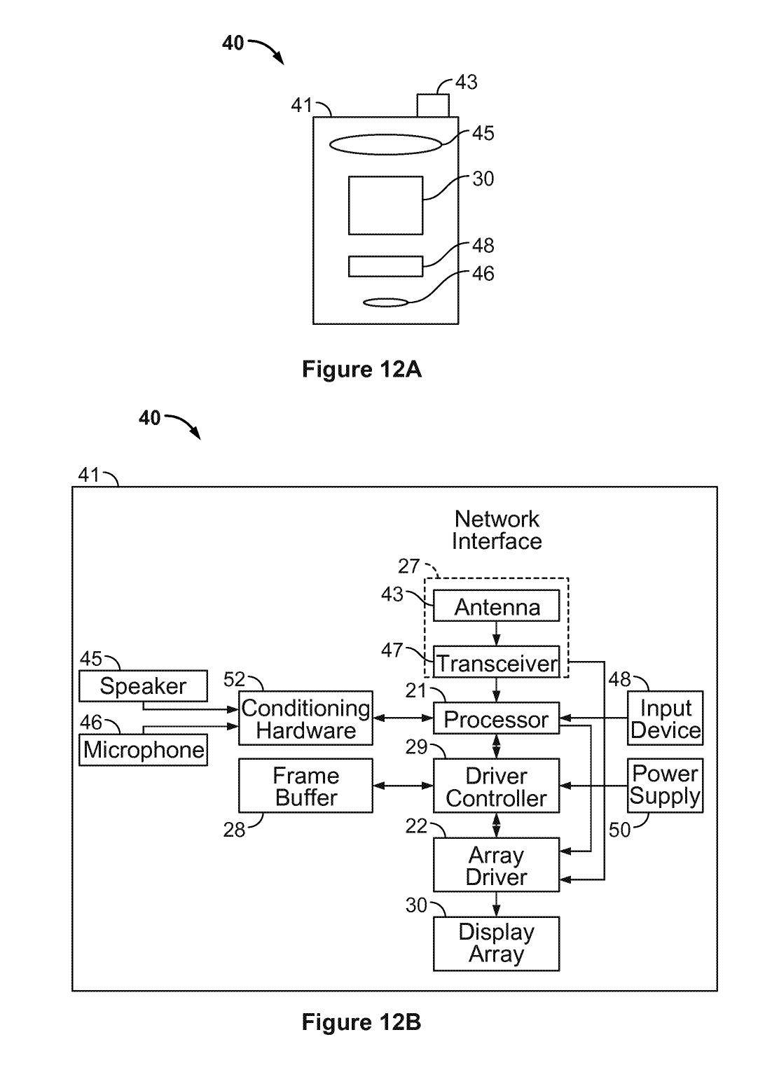

FIGS. 12A and 12B show examples of system block diagrams illustrating a display device 40 that includes a plurality of interferometric modulators. The display device 40 can be, for example, a smart phone, a cellular or mobile telephone. However, the same components of the display device 40 or slight variations thereof are also illustrative of various types of display devices such as televisions, tablets, e-readers, hand-held devices and portable media players.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 12B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller). Additionally, the array driver 22 can be a conventional driver or a bi-stable display driver (such as an IMOD display driver). Moreover, the display array 30 can be a conventional display array or a bi-stable display array (such as a display including an array of IMODs). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with display array 30, or a pressure- or heat-sensitive membrane. In some implementations, the input device 48 includes an instance of the optical touchscreen display techniques described above. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a first radiating element configured to emit, along a plane, first electromagnetic (EM) radiation toward a position-sensing region, the first EM radiation having a first wavelength;
a second radiating element configured to emit second EM radiation along the plane toward the position-sensing region, the second EM radiation having a second wavelength different from the first wavelength; and
at least one radiation sensor configured to detect scattered radiation, the detected scattered radiation resulting from interaction of the emitted first and second EM radiation with an object located in the position-sensing region, characteristics of the detected scattered radiation having a correlation with a position of the object in the position-sensing region, wherein the apparatus is configured to determine, from the correlation, a two dimensional position of the object.

2. The apparatus as recited in claim 1, wherein:
the first and second wavelengths are in the visible light range, the first wavelength corresponds to a first color, and the second wavelength corresponds to a second color;
the at least one radiation sensor includes a color sensor configured to determine a color of the detected scattered radiation; and
the correlation is based on the color of the detected scattered radiation.

3. The apparatus as recited in claim 1, further comprising:
a processor coupled to the radiation sensor, the processor configured to determine two dimensional coordinates of the position of the object in the position-sensing region based on the correlation.

4. The apparatus as recited in claim 3, wherein the processor is configured to determine a relative strength of a first scattered radiation compared to a second scattered radiation, wherein the first scattered radiation results from interaction of the emitted first EM radiation with the object and the second scattered radiation results from interaction of the emitted second EM radiation with the object.

5. The apparatus as recited in claim 1, wherein the first wavelength and the second wavelength are in a frequency range of EM radiation, the frequency range selected from the group consisting of: infrared radiation, visible light, and ultraviolet radiation.

6. The apparatus as recited in claim 1, wherein the radiating elements are light emitting diodes (LEDs) or lasers.

7. The apparatus as recited in claim 1, further comprising:
a medium situated in the position-sensing region of the plane.

8. The apparatus as recited in claim 7, wherein the medium is a transparent light guide.

9. The apparatus as recited in claim 7, wherein the medium is air.

10. The apparatus as recited in claim 1, further comprising:
a third radiating element configured to emit third EM radiation along the plane toward the position-sensing region, the third EM radiation having a third wavelength different from the first wavelength and the second wavelength.

11. The apparatus as recited in claim 1, wherein the apparatus includes a display screen having an external surface substantially parallel to the plane and proximate to the position-sensing region.

12. The apparatus as recited in claim 11, wherein the display screen has corners, each radiating element situated proximate to a different one of the corners.

13. The apparatus as recited in claim 11, wherein the display screen has sides, each radiating element situated proximate to a different one of the sides.

14. The apparatus as recited in claim 1, further comprising:
a touchscreen display, the touchscreen display including a display screen and the position-sensing region, the display screen having an external surface substantially parallel to the plane and proximate to the position-sensing region;
a processor that is configured to communicate with the display screen, the processor being configured to process image data; and
a memory device that is configured to communicate with the processor, wherein the touchscreen display is configured to receive input data and to communicate the input data to the processor.

15. The apparatus as recited in claim 14, further comprising:
a driver circuit configured to send at least one signal to the display.

16. The apparatus as recited in claim 15, further comprising:
a controller configured to send at least a portion of the image data to the driver circuit.

17. The apparatus as recited in claim 14, further comprising:
an image source module configured to send the image data to the processor.

18. The apparatus as recited in claim 17, wherein the image source module includes at least one of a receiver, transceiver, and transmitter.

19. An apparatus comprising:
a radiating element configured to emit first EM radiation, along a plane, toward a position-sensing region, the first EM radiation having a first wavelength;
a radiating element configured to emit second EM radiation along the plane toward the position-sensing region, the second EM radiation having a second wavelength different from the first wavelength; and
means for determining a two dimensional position of an object using scattered radiation resulting from interaction of the emitted first and second EM radiation with the object located in the position-sensing region.

20. The apparatus as recited in claim 19, further comprising:
a radiating element configured to emit third EM radiation along the plane toward the position-sensing region, the third EM radiation having a third wavelength different from the first wavelength and the second wavelength.

21. The apparatus as recited in claim 19, wherein the apparatus includes a display screen having an external surface substantially parallel to the plane and proximate to the position-sensing region.

22. A method comprising:
emitting, along a plane, first electromagnetic (EM) radiation toward a position-sensing region, the first EM radiation having a first wavelength;
emitting, along the plane, second EM radiation toward the position-sensing region, the second EM radiation having a second wavelength different from the first wavelength;
detecting scattered radiation, the detected scattered radiation resulting from interaction of the emitted first and second EM radiation with an object located in the position-sensing region, characteristics of the detected scattered radiation having a correlation with a position of the object in the position-sensing region; and
determining, from the correlation, a two dimensional position of the object.

23. The method as recited in claim 22, wherein determining, from the correlation, a two dimensional position of the object comprises determining, with a processor, a relative strength of a first scattered radiation compared to a second scattered radiation, wherein the first scattered radiation results from interaction of the emitted first EM radiation with the object and the second scattered radiation results from interaction of the emitted second EM radiation with the object.

24. The method as recited in claim 22, further comprising:
emitting, along the plane, third EM radiation toward the position-sensing region, the third EM radiation having a third wavelength different from the first wavelength and the second wavelength.

25. The method as recited in claim 22, wherein a user interface surface of a display screen is substantially parallel to the plane and proximate to the position-sensing region.

26. A non-transitory tangible computer-readable storage medium storing instructions executable by a computer to perform a process, the process comprising:
emitting, along a plane, first electromagnetic (EM) radiation toward a position-sensing region, the first EM radiation having a first wavelength;
emitting, along the plane, second EM radiation toward the position-sensing region, the second EM radiation having a second wavelength different from the first wavelength;
detecting scattered radiation, the detected scattered radiation resulting from interaction of the emitted first and second EM radiation with an object located in the position-sensing region, characteristics of the detected scattered radiation having a correlation with a position of the object in the position-sensing region; and
determining, from the correlation, a two dimensional position of the object.

27. The non-transitory tangible computer-readable storage medium as recited in claim 26, wherein determining, from the correlation, a two dimensional position of the object comprises determining, with the computer, a relative strength of a first scattered radiation compared to a second scattered radiation, wherein the first scattered radiation results from interaction of the emitted first EM radiation with the object and the second scattered radiation results from interaction of the emitted second EM radiation with the object.

28. The non-transitory tangible computer-readable storage medium as recited in claim 26, the process further comprising:
emitting, along the plane, third EM radiation toward the position-sensing region, the third EM radiation having a third wavelength different from the first wavelength and the second wavelength.

29. The non-transitory tangible computer-readable storage medium as recited in claim 26, wherein a user interface surface of a display screen is substantially parallel to the plane and proximate to the position-sensing region.

30. An apparatus comprising:
a plurality of first radiating elements, each configured to emit, along a plane, modulated first electromagnetic (EM) radiation toward a respective portion of a position-sensing region, the modulated first EM radiation having a first wavelength, wherein each of the plurality of first radiating elements is modulated in a mutually distinct manner;
a plurality of second radiating elements each configured to emit, along a plane, modulated second EM radiation toward a respective portion of a position-sensing region, the modulated second EM radiation having a second wavelength different from the first wavelength, wherein each of the plurality of second radiating elements is modulated in a mutually distinct manner;
at least one radiation sensor configured to detect scattered radiation, the detected scattered radiation resulting from interaction of the emitted modulated first and second EM radiation with an object located in the position-sensing region, characteristics of the detected scattered radiation having a first correlation with a position of the object in the position-sensing region; and
a processor coupled to the at least one radiation sensor, wherein the processor is configured to determine, from the correlation, a two dimensional position of the object.

32. The apparatus as recited in claim 31, wherein the apparatus is a display screen having a user interface surface substantially parallel to the plane and proximate to the position-sensing region.

33. The apparatus as recited in claim 30, wherein the processor is configured to determine, from the correlation, a two dimensional position of at least two objects simultaneously present in the position-sensing region.

34. The apparatus as recited in claim 30, wherein characteristics of the detected scattered radiation, resulting from a first intensity and a first duty cycle of the modulated first EM radiation and a second intensity and a second duty cycle of the modulated second EM radiation, have a correlation with a position of one or more objects in the position-sensing region, and the apparatus is configured to determine, from the correlation, a two dimensional position of the one or more objects.
